(19) United States
(12) Patent Application Publication
(10) Pub. No.: US 2018/0260769 A1
(43) Pub. Date: Sep. 13, 2018

(54) SUPPLY CHAIN ANALYTICS TOOL

(71) Applicant: Accenture Global Solutions Limited, Dublin (IE)

(72) Inventors: Basheer Ahmed, Chennai (IN); Pankaj Kumar Adiyodi, Chennai (IN); Prakash Gabriel John Victor, Chennai (IN); Kedar Vishwanath Girdhari, Chennai (IN); Mohideen Basheer Ahmed, Chennai (IN); Balaji Krishnamoorthy, Chidambaram (IN); Oviamathi Karunanidhi, Bangalore (IN); Jayaraman Neruppur Sadasivam, Kancheepuram (IN); Satish Mani, Chennai (IN); Raj Onkar, Mumbai (IN); Neethu Manalel Sivan, Jellippara (IN)

(73) Assignee: Accenture Global Solutions Limited, Dublin (IE)

(21) Appl. No.: 15/913,360

(22) Filed: Mar. 6, 2018

(30) Foreign Application Priority Data
Mar. 7, 2017 (IN) 201741007898

(51) Int. Cl. G06Q 10/08; G06F 17/30; G06N 99/00

(52) U.S. Cl. CPC G06Q 10/087; G06N 99/005; G06F 17/30377

(57) ABSTRACT

By way of an introductory example, the system may communicate a display interface comprising a plurality of prioritized component information for a supply chain. The system may acquire priority models associated with respective priority factors that are used to prioritize the component information. Each of the priority models may be configured to process information based on the respective priority factors. The system may further acquire selection criteria associated with the component identifier. The system may select, based on the selection criteria, the priority models that are relevant to prioritizing the component identifier. The system may determine an updated priority metric for the component identifier by applying production information to the selected priority models.

### CROSS REFERENCE TO RELATED APPLICATIONS

This application claims the benefit of Indian Provisional Application No. 201741007898 filed Mar. 7, 2017, the entirety of which is hereby incorporated by reference.

### TECHNICAL FIELD

This disclosure relates to inventory management tools and, in particular, to prioritized data acquisition and analytics in a supply chain system.

### BACKGROUND

A supply chain may include many information systems that are involved in the production and distribution of products. In many circumstances, the information systems may independently operate separate information systems related to their individual contributions to the supply chain. The decoupled and uncoordinated nature of the information systems may cause production delays, quality issues, and other inefficiencies in delivery assurance.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates a first example of a system;

FIG. 2 illustrates an example of a flow diagram of logic for a system;

FIG. 3 illustrates a first example of a display interface for a system;

FIG. 4 illustrates a second example of a display interface for a system; and

FIG. 5 illustrates an example of a system with a processor and a memory.

### DETAILED DESCRIPTION

By way of an introductory example, the system may communicate a display interface comprising a plurality of component identifiers accessed from a database. The component identifiers may correspond to respective components included in a supply chain. The components identifiers may be previously prioritized based on respective priority metrics that were determined for each of the respective components.

The system may acquire priority models associated with respective priority factors. Each of the priority models may process information based on the respective priority factors. The system may further acquire selection criteria associated with the component identifiers. The selection criteria may include weight values. Each of the weight values may be associated with a corresponding one of the priority models.

The system may select, based on the selection criteria, the priority models that are associated with a corresponding weight value greater than a threshold weight value. The system may acquire production information previously tagged with the respective priority factors that are associated with the selected priority models. The system may determine an updated priority metric for the component identifier by applying the production information to the selected priority models. The system may reprioritize the component identifiers corresponding to the respective components based on the priority metric.

One example of an interesting feature provided by the systems and methods described may be that separate priority models may be utilized for each component, enabling a particular component to have a customized priority model. The customized priority model may be configured to provide the most accurate analysis with a low demand on hardware resources. The information generated by the customized priority models may be included in graphical user interfaces that display the relevant information for each component identifier.

Another example of an interesting feature provided by the systems and methods described may that machine learning may generate, update, and/or manage the priority models to improve accuracy, precision, recall, and processing time. As the priority models are improved, components which cause high variation in the supply chain may be quickly and accurately prioritized without the errors or inaccuracies caused by human decision.

The systems and methods described herein offer improvements over existing market solutions. The additional benefits, efficiencies, and improvements over existing market solutions are made evident in the systems and methods described below.

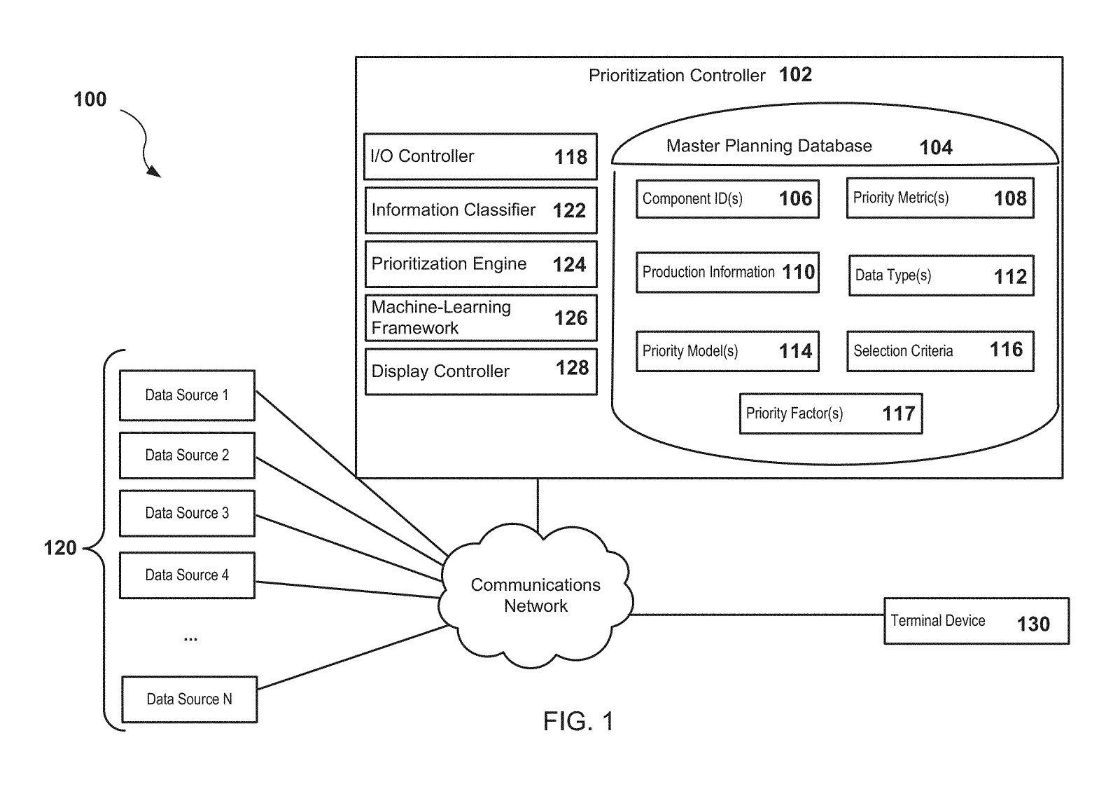

FIG. 1 illustrates a first example of a system 100. The system 100 may include a prioritization controller 102. The prioritization controller 102 may include a master planning database 104.

The master planning database 104 may include a database that stores information used to prioritize individual components of a product. The database may include a relational or non-relational database. Alternatively or in addition, the database may include multiple databases that are associated with each other and/or individually accessed.

The master planning database 104 may store a component identifier 106 and a priority metric 108. The component identifier 106 may correspond to a component of a product made or used in a supply chain. The component associated with the component identifier may be any material, part, hardware, software, and/or work-in-progress that is used to produce, deliver, and/or complete a product. The component identifier 106 may include a primary key, a secondary key, a description, a label, and/or any other identifying information corresponding to the component. The master planning database 104 may include multiple components identifiers. One or more of the component identifiers may be associated with a product or product identifiers (not shown in FIG. 1).

The priority metric 108 may include a measurement of the importance of a component in the supply chain. For example, the priority metric 108 may include a measurement of risk associated with the component due to potential delays, quality problems, and/or other variances in predetermined key performance indicators. In an implementation, the priority metric 108 may include of a delay or a forecasted delay. Alternatively or in addition, the priority metric 108 may include a schedule variance, a change in lead-time, a quality control variance, and/or any other key performance indicator or key performance indicator variance. The master planning database may store an association between multiple components and corresponding priority metrics.

Priority metrics may be used to prioritize components in a supply chain. Prioritized components may enable efficient tracking, monitoring, and/or management of the supply chain. For example, graphical users interfaces may display the prioritized component identifiers, or prioritized information associated with the component identifiers, enabling users to easily identify information that may be used as a basis to improve the supply chain. Alternatively or in addition, prioritization may improve computer-implemented monitoring, tracking, and management of the supply chain as computing resources are allocated to handling higher priority components before lower priority components. For example, calculation of the priority metrics may involve computations, I/O operations, and/or other tasks that contribute to processing time. Minimizing the processing time may result in smoother operation of graphical user interfaces and faster resolution of supply chain problems.

The master planning database 104 may include additional information and constructs used to acquire and analyze information used to prioritize the component identifier 106. For example, the master planning database 104 may include production information 110, data types 112, priority models 114, and/or selection criteria 116, and/or priority factors 117.

The production information 110 may include any information that is related to operation of a supply chain and/or the production of one or more components. For example, the production information 110 may include status, time, and/or quality information. In some examples, the production information 110 may include inventory counts, milestones, delivery dates; status updates process status information, changes done to production plan within specified time, process quality checks. Alternatively or in addition, the production information may include approval information, such as whether approval of designs has been obtained or is needed prior to manufacturing a component. Further, the production information may further include any information, used to calculate a priority factor (see Table 1 below).

The system 100 may include an I/O controller 118. The I/O controller 118 may include any endpoint configured to send and/or receive information (e.g. a network interface, a messaging service, an application programming interface, and the like). The I/O controller 118 may receive the production information 110 from one or more data sources 120. The data sources 120 may provide information related to production of one or more components or products. The data sources 120 may include one or more servers, databases, and/or any other source of production information. Any of the data sources may be physically separated from the prioritization controller 102 and/or communicate with the prioritization controller 102 via a communications network. When the production information 110 is received from one or more of the data sources 120, the I/O controller 118, or some other system component in communication with the I/O controller 118, may store the production information 110 in the master planning database 104.

Analysis of the production information 110 may result in changes to the prioritization of the component identifiers. Categorizing and/or classifying the received production data may enable improved analysis and decreased computing times. For example, a particular component identifier may be associated with a first category and not a second category. When determining the priority for the particular component identifier, the production information 110 associated with the second category may be ignored while production data associated with the first category may be utilized. The corresponding priority metric for each of the component identifiers may be uniquely calculated by differentiating between the categories for each component identifier.

The system 100 many include an information classifier 122. The information classifier 122 may categorize the production information 110. For example, the information classifier 122 may access a data type that is used to classify the production information. In some examples, the master planning database 104 may store the data types 112. The information classifier 122 may tag production data with the one or more of the data types 112. Tagging the production information 110 refers to assigning, associating, and/or linking information to the production information.

The data type may include an identifier, description, and/or other information that categorizes or summaries production information. For example, the data type may include a predetermined category. In some examples, the master planning database 104 may include one or more data type. The datatype may be associated with pieces of the production information 110 and/or one or more data sources 120.

Alternatively or in addition, the information classifier 122 may tag the production information 110 with one or more of the priority factors 117. A priority factor may include an identifier of a contributing reason for a change in priority. For example, the priority factors may include or identify contributing reasons for a delay, change in quality, and/or any other reasons for variations from a key performance indicator.

In some examples, the master planning database 104 may store the priority factors 117. For example, the priority factor 117 may be stored in the master planning database 104 as an identifier, such as a primary key or foreign key. Alternatively or in addition, the priority factor may include and/or reference other data used to acquire, analyze and/or categorize the production information. For example, the master planning database 104 may include associations between the priority model, the data type, and/or the data source. Table 1 lists examples of the data sources 120, data types 112, and the priority factors 117.

TABLE 1
Priority Factors

| Priority Factor | Data Type | Data Source |
|---|---|---|
| No of priorities supplier | Supplier Status | Risk management tool |
| is dealing with | | |
| Next delivery date | Order Attribute | Risk List |
| Approval For Layouts | Process Status | Weekly Report |
| Skip Lot( Quality | Material Attribute | Master File |
| Approval material) | | |
| Delay in raw material | Material Attribute | Delay history reason |
| allocation | and History | |
| Lead Time | Material Attribute | Material Attribute |
| Quality Score of supplier | History data for | QN report |
| | Supplier Attribute | |
| Exit Supplier | Supplier Attribute | Supplier Status Report |
| Engg Changes | Process Status | EC report |
| Guidelines | Supplier Attribute | Contracts |
| Quantity of order | Order Attribute | Risk List |
| Supplier Criticality | Supplier Attribute | Calculated KPI |
| (Client and supplier | | |
| relation; Flexibility of | | |
| supplier) | | |
| Number of pulls in for | Process Status | Risk management tool |
| recent two months | | |
| Number of push outs in | Process Status | Risk management tool |
| recent 2 months | | |
| Successful pull-ins in | History Data for | Risk management tool, |
| historical data | Process Status | Risk lists etc |
| Demand Variability | History Data for | (Forecast-Actual) |
| | Process Status | |
| Supply Variability | Supplier Attribute | (Promised-Actual ship |
| | | date) |
| Lot Size | Material attribute | Material report |

The system may include a prioritization engine 124. The prioritization engine 124 may determine the corresponding priority metric for one or more component identifiers. The prioritization engine 124 may calculate the corresponding priority metric based on the production information 110 and/or categorized production information. Alternatively or in addition, the prioritization engine 124 may determine the corresponding priority metric based on one or more of the priority models 114.

The priority model may include a model that determines or forecasts variances in a supply chain from an expected result. Variances in the supply chain may include deviations from predetermined goals, such as delivery dates, quality levels, productivity, and/or any other criteria relevant to a supply chain. The priority model may include equations, algorithms, rules, and/or logic that determines the variance in the supply chain. For example, supply chain may use key performance indicators that identify the operational performance of the supply chain in terms of delivery assurance, quality assurance, and/or any other relevant criteria. In some examples, the key performance indicators may be compared with predetermined thresholds included in service level agreements to identify variances in the supply chain. Alternatively or in addition, the performance indicators may be compared with historical information to identify trends, correlations, or other statistically significant information that is used to forecast variance in the supply chain.

The prioritization engine 124 may select a unique combination of priority models for a particular component identifier. The prioritization engine 124 may determine the priority metric 108 based on the unique combination of priority models. Alternatively or in addition, the master planning database 104 may associate one or more unique combinations of priority models with one or more component identifiers. For example, a first component identifier may be associated with a first combination of priority models and a second component identifier may be associated with a second combination of priority models.

The prioritization engine 124 may access selection criteria to determine the unique combination of priority models. The selection criteria 116 may include criteria that identifies the relevance of one or more of the priority models 114 for a particular component. In some examples, the selection criteria 116 may be associated with one or more component identifiers. The master planning database 104 may include multiple selection criteria 116. For example, a first component identifier may be associated with a first selection criteria and a second component identifier may be associated with a second selection criteria.

Using the selection criteria 116 to select priority models may reduce the number of priority models used to calculate the priority metric 108. For example, some of the priority models 114 may have less relevance for determining a corresponding priority metric for a particular component identifier. The selection criteria 116 may cause the prioritization engine 124 to ignore some of the priority models 114 and use other priority models. The processing time required to achieve confident prediction information may be reduced by using the selection criteria 116.

In some examples, the selection criteria 116 may include coefficients and/or weights. Each of the weights may include a measurement of relevance for particular component identifier. The prioritization engine 124 may assign the weights to individual priority models. The prioritization engine 124 may select the priority models 114 that are assigned or associated with weights that are greater than a threshold weight value. The selected priority models may include a unique combination of priority models for a particular component identifier or multiple component identifiers.

In an implementation, the prioritization engine 124 may calculate the priority metric 108 according to the following formula:

Dijk=x1*f(Pijk)+x2*f(Oijk)+x3*f(Hijk),+ . . . +x17*f(LTk)) Equation 1

In this example, i may denote a time window, j may denote time window of next planned order, and k may denote a component or material to be pulled in. The variable Dijk may refer to the calculated priority metric. For example, Dijk may refer to a delay for pulling in k material from jth week to ith week. The variable Pijk may refer to a number of pulls-ins for k material in recent months for i-j window. The variable Oijk may refer to a number of push-outs for k material in recent months for i-j window. The variable Hijk may refer to a percentage of successful pull-ins in historical data for k material in i-j window. The variable DVijk may refer to demand variability for material k measured at i-jth window. For example, DVijk may be calculated by taking difference of a forecast done on week i for jth week and actual on jth week. The variable SVk may refer to supply variability for material k. Alternatively or in addition, the formula may include supplier reliability which can be measured as a difference of promise date—actual date. The variable LTk may refer to the lead time for a component or material K, which may also be indicative of manufacturing complexity.

The prioritization engine 124 may generate the priority metric 108 based on a combination, or a weighted combination, of one or more performance indicator metrics. A performance indicator metric may include a measurement of a priority factor using the production information. The performance indicator metric may be calculated using a particular priority model. For example, the performance information 110 may applied to the priority model and the priority model may determine the performance indicator.

One or more priority models, or combination of priority models, may generate a priority metric based on the performance indictor metrics. In the example illustrated above, performance indicator metrics may include the output of Pijk, f(Pijk), f(Oijk), f(Hijk), etc. Alternatively or in addition, the selection criteria 116 may include the values X1, X2, X3, etc. described in the example above.

The associations between the priority model, the selection criteria 116, and/or the component identifiers may be configured in many ways. For example, the component identifiers may be associated with the priority factors, such as the priority factors identified in Table 1. Each of the priority factors may be assigned or associated with a corresponding priority model. The selection criteria 116 may identify the relevant priority factors and/or the relevant priority models for a component.

The system may further include a machine-learning framework 126. The machine-learning framework 126 may generate and/or maintain the selection criteria 116 and/or the priority model. Historical information including, for example, the production information 110 received from the data sources 120, may be split into training sets and test sets. The machine-learning framework 126 may built from the training sets to generate statistical rules such that the performance of the selection criteria 116 and/or the priority models 114 exceeds a desired threshold in terms of statistics such as accuracy, confidence, probability, precision and recall. A test set is applied to the selection criteria 116 and/or the priority models 114 to determine if performance is satisfactory. The selection criteria 116 and/or the priority models 114 may be added and/or updated in the master planning database 104. Alternatively or in addition, the machine learning framework 126 may use multi-linear regression using Lasso or Ridge which in turn uses gradient descent algorithms to find out optimum/close to optimal solutions for each coefficient priority models 114 using selection criteria 116.

In some examples, the machine-learning framework 126 may receive feedback that causes the priority model and/or the selection criteria 116 to be reconfigured. For example, a user may provide feedback formation related to a weight assigned to the selection criteria 116 for one or more component identifier. The machine-learning framework 126 may re-generate one or more selection criteria 116 and/or one or more priority model based on the feedback.

The system may further include a display controller 128. The display controller 128 may generate, communicate, and/or cause to display one or more graphical user interfaces. For example, the display controller 128 may generate a graphical user interface that displays one or more prioritized component identifiers and/or prioritized component information. In some examples, the display controller 128 may update the graphical user interfaces, in real-time, based on reprioritizations of the component identifiers and other information related to the components. The display controller may communicate a user interface, such as a graphical user interface to a terminal device 130 for display. The terminal device 130 may include, among other things, a screen configured to display the graphical user interface. In some examples, the terminal device 130 may remotely communicate with the prioritization controller over a communications network. For example, the graphical user interface may include a web page and/or logic that causes the terminal device to display information in a particular manner. Alternatively, the terminal device 130 may include the prioritization controller and/or communicate directly with the prioritization controller 102. For example, the display controller 102 may send signals to the terminal device 130 to display the graphical user interface.

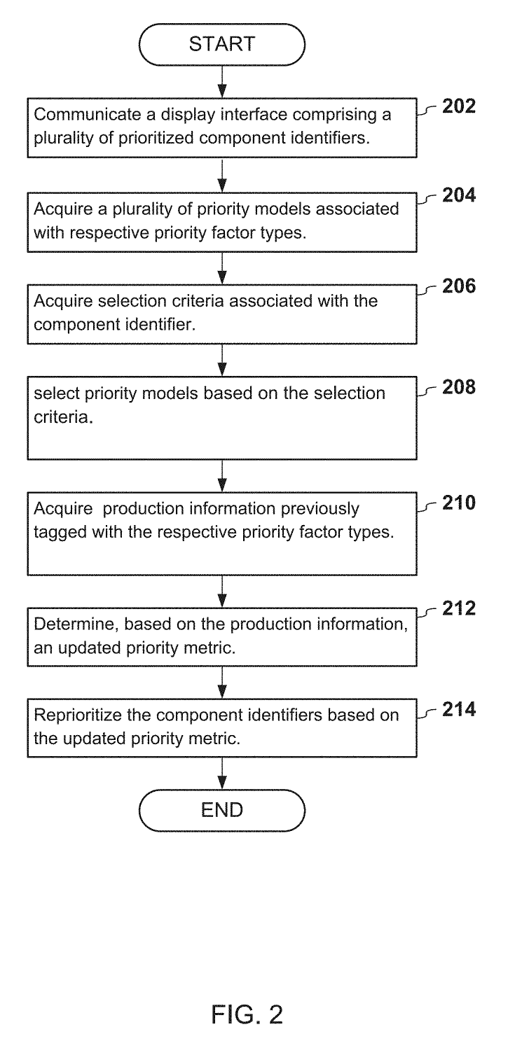

FIG. 2 illustrates an example of a flow diagram of logic for the system 100. The display controller 128 may communicate a display interface comprising a plurality of prioritized component identifiers. (202) For example, the display controller 128 may communicating a display interface, such as a graphical user interface, configured to display a plurality of component identifiers accessed from the master planning database 104. The component identifiers may correspond to respective components included in a product and/or included in a supply chain. The components identifiers may have been previously prioritized based on respective priority metrics previously determined for each of the respective components.

The prioritization engine 124 may acquire a plurality of priority models associated with respective priority factors (204). For example, each of the priority models 114 may be configured to process production information 110 based on the respective priority factors. For example, a first priority model may determine or forecast a delay based on the quality score of a supplier

The prioritization engine 124 may acquire selection criteria associated with the component identifier 106 (206). The selection criteria 116 may include weight values. Each of the weight values may be associated with a corresponding one of the priority models 114. For example, the master planning database 104 may include a link or an association between the one or more of the weight values and one or more of the priority models 114.

The prioritization engine 124 may select priority models based on the selection criteria 116 (208). For example, the prioritization engine 124 may select the priority models 114 that are associated with a corresponding weight value greater than a threshold weight value. The threshold weight value may include a threshold by which the priority models 114 are used or not used to calculate the priority metric 108.

The prioritization engine 124 and/or the IO controller may acquire production information 110 previously tagged with the respective priority factors (210). For example, the IO controller may receive production information 110 updates from a plurality of data sources 120. The information classifier 122 may tag the received the production information 110 included in the production information 110 updates one or more priority factors associated with the priority models 114. The information classifier 122 may store the tagged production data in a database. Alternatively or in addition, the information classifier 122 may communicate the tagged production information (or a notification indicative of tagged production information) to the prioritization engine 124 in real time. The prioritization engine 124 may acquire the tagged production information. Instead of acquiring all of the tagged production information, the prioritization control may acquire the tagged production information associated with one or more priority factors that are associated with the selected priority models. Instead of acquiring data for all of the available priority models, only the relevant priority models may be used. The relevance of the priority models 114 may have been previously determined using the selection criteria 116.

The prioritization engine 124 may determine, based on the production information, an updated priority metric (212). For example, the priority engine may determine an updated priority metric for the component identifier 106 by applying the production information 110 to the selected priority models. Instead of utilizing all of the available priority models, only the selected priority models may be used. In some examples, the prioritization engine 124 may calculate using the selected priority models, performance indicator metrics. One or more of the performance indicator metrics may be calculated by using a corresponding one of the selected priority models. The prioritization engine 124 may weight each of the performance indicator metrics with at least one of the weight values included in the selection criteria 116. The prioritization engine 124 may generate the priority metric based on a weighted combination of the performance indicator metrics and the weights of the selection criteria 116.

The prioritization engine 124 may reprioritize the component identifiers based on the updated priority metric (214). For example, the prioritization engine 124 may store and/or associate the updated priority metric with a particular component identifier. In some examples, the prioritization engine 124 may reorder the identifiers 106 in the master planning database based corresponding priority metrics. Alternatively or in addition, the display controller may update one or more graphical user interface in response to the reprioritization of one or more component identifiers.

The steps may include additional, different, or fewer operations than illustrated in FIG. 2. In addition, the steps may be performed in a different order than illustrated in FIG. 2

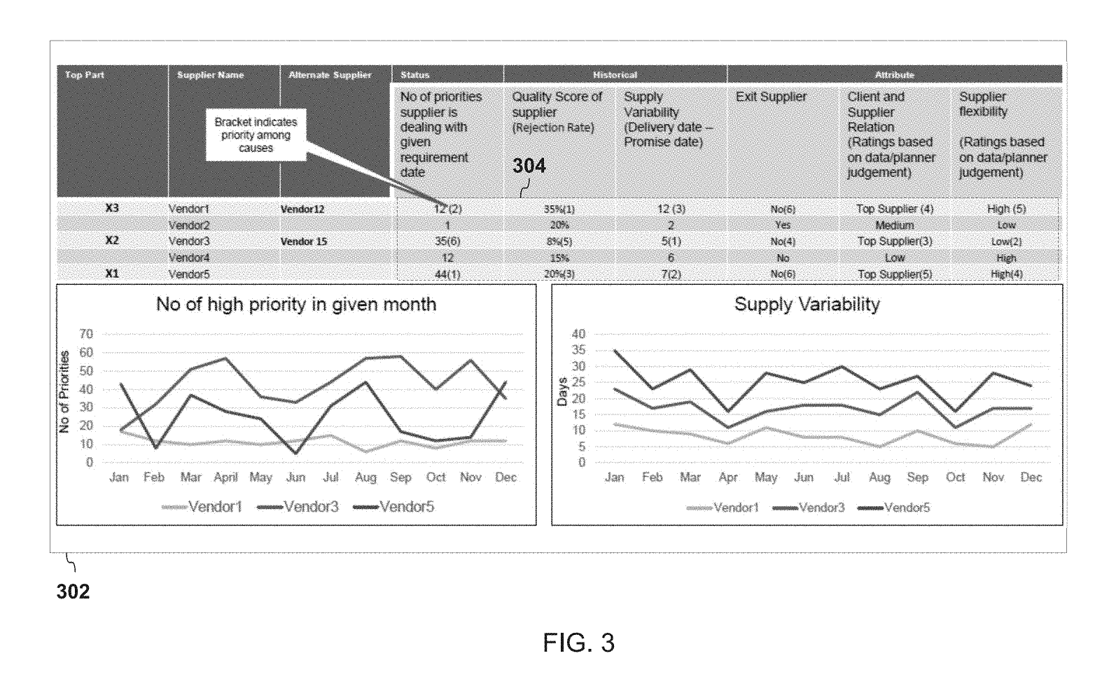

FIG. 3 illustrates a first example of a display interface 302 for the system 100. The display interface 302 may include priority contribution information 304. The priority contribution information 304 may include production information that was previously tagged with one or more data types and/or one or more priority factors. Alternatively or in addition, the priority contribution information 304 may include performance indicators, priority factors, data types, priority metrics, and/or any other information stored in the master planning database 102. For example, the priority contribution information 304 illustrated in FIG. 3 includes performance indicator metrics associated with the component identifiers X3, X2, and X1. For X3, the performance indicator metrics corresponding to “Quality Score of Supplier” is “12”. For X2, the performance metric corresponding to “supply variability” is 5. For X1, the performance metric corresponding to with “Supplier Flexibility” is “high”.

The priority contribution information 304 may be visually prioritized based on the priorities of corresponding components. For example, the priority contribution information 304 illustrated in FIG. 3 is visually prioritized based on the priorities of the component identifiers labeled X3, X2, X1. The corresponding components X3, X2, and/or X1 may each be associated with respective priority metrics. As updated production information is received and the priority metrics change, the layout of the priority contribution information 304 may also change.

In some examples, the priority contribution information 304 may further include one or more the selection criteria used to select the priority models selected for a particular component. For example, in the example illustrated in FIG. 3, the quality score (performance indicator) of supplier for X3 is “35%”. The weight value of the selection criteria used to prioritize X3 is “(1)” and is displayed next to the quality score.

In some examples, the priority contribution information 304 may include corresponding groups of performance indicators for one or more of the prioritized component identifiers. For example, the priority contribution information 304 may include a first corresponding group of performance indicators for a first supplier and a second corresponding group of performance indicators for a second supplier. In the example illustrated in FIG. 3, the display interface 302 includes the suppler associated with each component X3, X2, and X1. The component X3 is associated with the first supplier named “vendor 1” and the second supplier named “vendor 2”. The priority contribution information 304 includes a first group of performance indicators associated with the first supplier and a second group of performance indicators associated with the second supplier. In other examples, the display interface may display any number of suppliers for each component and the production information, performance indicators, and/or calculated metrics associated with each supplier.

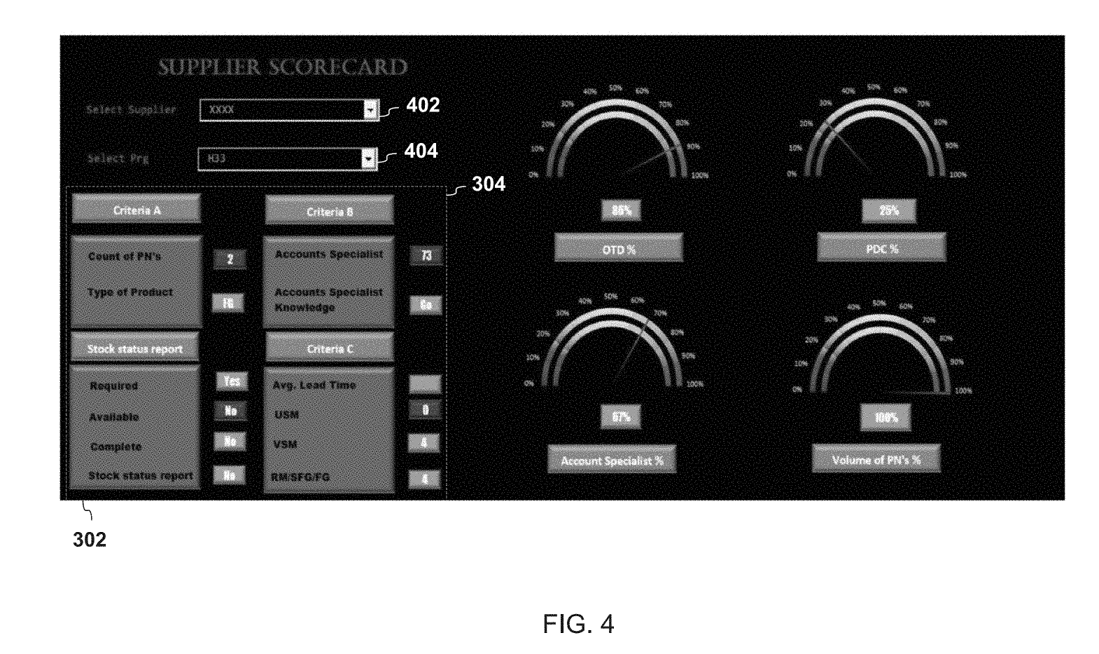

FIG. 4 illustrates a second example of the display interface 302 for the system 100. The display interface 302 may include a first field 402 that enables selection of a supplier. In addition, the display interface 302 may include a second field 404 that enables selection of a component. The display interface may display the priority contribution information based on selected component and/or the selected supplier. As previous discussed, different production information, priority models, priority factors, and/or performance indicators may have been used to determine the priority of each component. Accordingly, the priority contribution information may change, depending on the selected component.

The system 100 may be implemented with additional, different, or fewer components than illustrated. Each component may include additional, different, or fewer components.

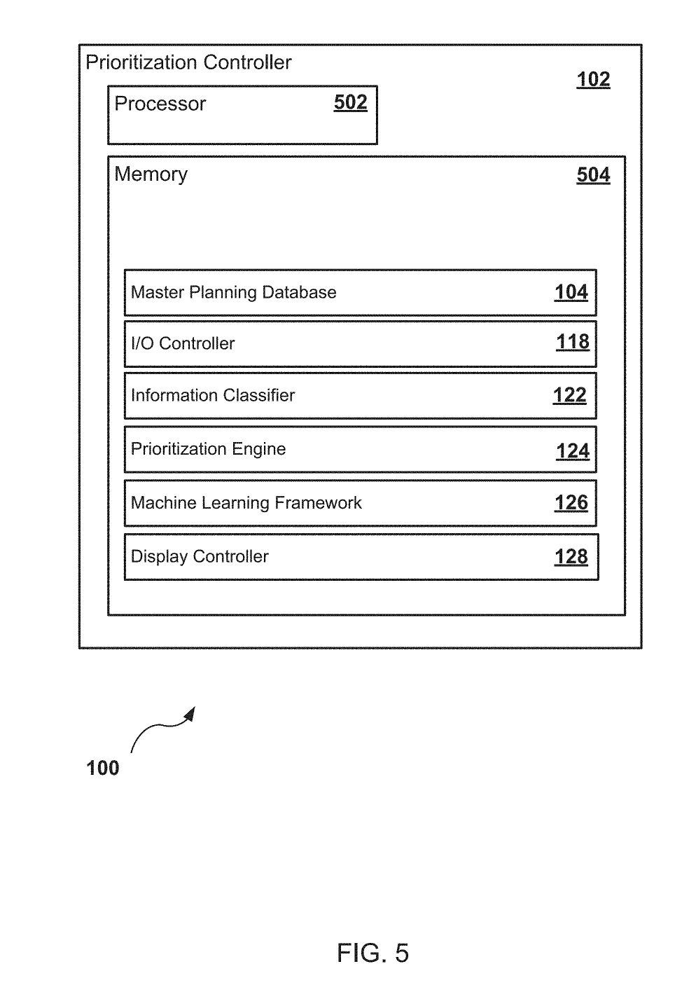

FIG. 5 illustrates an example of the system 100 that includes a processor 502 and a memory 504. The processor 502 may be in communication with the memory 504. In one example, the processor 502 may also be in communication with additional elements, such as a network interface (not shown). Examples of the processor 502 may include a general processor, a central processing unit, a microcontroller, a server, an application specific integrated circuit (ASIC), a digital signal processor, a field programmable gate array (FPGA), and/or a digital circuit, analog circuit, or some combination thereof.

The processor 502 may be one or more devices operable to execute logic. The logic may include computer executable instructions or computer code stored in the memory 504 or in other memory that when executed by the processor 502, cause the processor 502 to perform the features implemented by the logic of the I/O controller 118, the information classifier 122, the prioritization engine 124, the machine-learning framework 126, the display controller 128, and/or the system 100. The computer code may include instructions executable with the processor 502.

The memory 504 may be any device for storing and retrieving data or any combination thereof. The memory 504 may include non-volatile and/or volatile memory, such as a random access memory (RAM), a read-only memory (ROM), an erasable programmable read-only memory (EPROM), or flash memory. Alternatively or in addition, the memory 504 may include an optical, magnetic (hard-drive) or any other form of data storage device. The memory 504 may include at least one the I/O controller 118, the information classifier 122, the prioritization engine 124, the machine-learning framework 126, the display controller 128, the master planning database 104 and/or the system 100.

The system 100 may be implemented in many different ways. For example, each component of the system may include a circuit or circuitry. Each circuit or circuitry may be hardware or a combination of hardware and software. The circuitry may include the I/O controller 118, the information classifier 122, the prioritization engine 124, the machine-learning framework 126, the display controller 128, the master planning database 104, and/or other components and subcomponents of the system 100 described herein. For example, each circuit or circuitry may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each circuitry may include memory hardware, such as a portion of the memory 504, for example, that comprises instructions executable with the processor 502 or other processor to implement one or more of the features of the circuitry. When any one of the circuitry includes the portion of the memory that comprises instructions executable with the processor 502, the circuitry may or may not include the processor 502. In some examples, each circuitry may just be the portion of the memory 504 or other physical memory that comprises instructions executable with the processor 502 or other processor to implement the features of the corresponding circuitry without the circuitry including any other hardware. Because each circuitry includes at least some hardware even when the included hardware comprises software, each circuitry may be interchangeably referred to as a hardware circuitry.

Some features are shown stored in a computer readable storage medium (for example, as logic implemented as computer executable instructions or as data structures in memory). All or part of the system 100 and its logic and data structures may be stored on, distributed across, or read from one or more types of computer readable storage media. Examples of the computer readable storage medium may include a hard disk, a floppy disk, a CD-ROM, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device.

The processing capability of the system 100 may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL)).

All of the discussion, regardless of the particular implementation described, is illustrative in nature, rather than limiting. For example, although selected aspects, features, or components of the implementations are depicted as being stored in memory(s), all or part of the system or systems may be stored on, distributed across, or read from other computer readable storage media, for example, secondary storage devices such as hard disks, flash memory drives, floppy disks, and CD-ROMs. Moreover, the various modules, circuitry and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network or over telephone lines. In yet other examples, the logic or instructions are stored within a given computer, central processing unit (“CPU”), graphics processing unit (“GPU”), or system.

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same apparatus executing a same program or different programs. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. A method comprising,
communicating a display interface comprising a plurality of component identifiers accessed from a database, the component identifiers corresponding to respective components included in a supply chain, the component identifiers prioritized based on a plurality of respective priority metrics previously determined for each of the respective components;
acquiring a plurality of priority models associated with respective priority factors, each of the priority models configured to process information based on the respective priority factors;
acquiring selection criteria associated with the component identifiers, the selection criteria comprising a plurality of weight values, each of the weight values associated with a corresponding one of the priority models;
selecting, based on the selection criteria, the priority models that are associated with a corresponding weight value greater than a threshold weight value;
acquiring production information previously tagged with the respective priority factors that are associated with the selected priority models;
determining an updated priority metric for the component identifiers by applying the production information to the selected priority models; and
reprioritizing the component identifiers corresponding to the respective components based on the updated priority metric.

2. The method of claim 1, further comprising:
communicating an updated display interface comprising the component identifiers reprioritized based on the updated priority metric.

3. The method of claim 1, wherein the step of determining the updated priority metric further comprises:
calculating, using the selected priority models, performance indicator metrics, wherein each of the performance indicator metrics are calculated using a corresponding one of the selected priority models;
weighing each of the performance indicator metrics with at least one of the weight values included in the selection criteria; and
generating the updated priority metric based on a weighted combination of the performance indicator metrics and the weight values included in the selection criteria.

4. The method of claim 1, further comprising:
calculating, using the selected priority models, delay metrics using production information tagged with the respective priority factors; and
generating the updated priority metric based on a weighted combination of the delay metrics and the selection criteria, wherein the updated priority metric comprises a production delay corresponding to at least one of the component identifiers.

5. The method of claim 1, further comprising:
receiving production information from a plurality of remote data sources;
tagging the production information with at least one respective priority factor for the priority models; and
storing the tagged production information in a database.

6. The method of claim 1, further comprising:
generating the display interface, the display interface including a list of the component identifiers and priority contribution information, wherein the priority contribution information is prioritized according to prioritization metrics calculated for the component identifiers, and wherein the priority contribution information includes performance indicators previously calculated using the production information.

7. The method of claim 6, wherein the priority contribution information further includes at least one of the weights of the selection criteria used to select the selected priority models.

8. A system comprising:
a processor, the processor configured to:
communicate a display interface comprising a plurality of component identifiers accessed from a database, the component identifiers corresponding to respective components included in a supply chain, the component identifiers prioritized based on a plurality of respective priority metrics previously determined for each of the respective components;
acquire a plurality of priority models associated with respective priority factors, each of the priority models configured to process information based on the respective priority factors;
acquire selection criteria associated with the component identifiers, the selection criteria comprising a plurality of weight values, each of the weight values associated with a corresponding one of the priority models;
select, based on the selection criteria, the priority models that are associated with a corresponding weight value greater than a threshold weight value;
acquire production information previously tagged with the respective priority factors that are associated with the selected priority models;
determine an updated priority metric for the component identifier by applying the production information to the selected priority models; and
reprioritize the component identifiers corresponding to the respective components based on the updated priority metric.

9. The system of claim 8, wherein the processor is further configured to:
communicate an updated display interface comprising the component identifiers reprioritized based on the updated priority metric.

10. The system of claim 8, wherein to determine the updated priority metric, the processor is further configured to:
calculate, using the selected priority models, performance indicator metrics, wherein each of the performance indicator metrics are calculated using a corresponding one of the selected priority models;
weigh each of the performance indicator metrics with at least one of the weight values included in the selection criteria; and
generate the priority updated metric based on a weighted combination of the performance indicator metrics and the weights of the selection criteria.

11. The system of claim 8, wherein the processor is further configured to:
calculate, using the selected priority models, delay metrics using production information tagged with the respective priority factors; and
generate the updated priority metric based on a weighted combination of the delay metrics and the selection criteria, wherein the updated priority metric comprises a production delay corresponding to the component identifier.

12. The system of claim 8, wherein the processor is further configured to:
receive the production information from a plurality of remote data sources;
tag the production information with at least one of the respective priority factors for the priority models; and
store the tagged production information in a database.

13. The system of claim 8, wherein the processor is further configured to:
generate the display interface, the display interface including a list of the component identifiers and priority contribution information, wherein the priority contribution information is prioritized according to prioritization metrics calculated for the component identifiers, wherein the priority contribution information includes performance indicators previously calculated using the production information.

14. The system of claim 8, wherein the processor is further configured to:
generate a display interface, the display interface including priority contribution information indicative of production information used to prioritize a first component identifier; and
update, in response to a selection trigger, the display interface to include priority contribution information indicative of production information used to prioritize a second component identifier, wherein the selection trigger identifies the selection component identifier.

15. A non-transitory computer readable storage medium comprising instructions executable by a processor, the instructions comprising:
instructions executable by the processor to communicate a display interface comprising a plurality of component identifiers accessed from a database, the component identifiers corresponding to respective components included in a supply chain, the components identifiers prioritized based on a plurality of respective priority metrics previously determined for each of the respective components;
instructions executable by the processor to acquire a plurality of priority models associated with respective priority factors, each of the priority models configured to process information based on the respective priority factors;
instructions executable by the processor to acquire selection criteria associated with the component identifiers, the selection criteria comprising a plurality of weight values, each of the weight values associated with a corresponding one of the priority models;
instructions executable by the processor to select, based on the selection criteria, the priority models that are associated with a corresponding weight value greater than a threshold weight value;
instructions executable by the processor to acquire production information previously tagged with the respective priority factors that are associated with the selected priority models;
instructions executable by the processor to determine an updated priority metric for the component identifiers by applying the production information to the selected priority models; and
instructions executable by the processor to reprioritize the component identifiers corresponding to the respective components based on the updated priority metric.

16. The non-transitory computer readable storage medium of claim 15, further comprising:
instructions executable by the processor to receive, from a remote data source, an update corresponding to production information stored in the database; and
instructions executable by the processor to update the display interface in response to receipt of the update and reprioritization of the component identifiers.

17. The non-transitory computer readable storage medium of claim 15, further comprising:
instructions executable by the processor to generate at least one of the priority models using a machine-learning framework.

18. The non-transitory computer readable storage medium of claim 15, further comprising:
instructions executable by the processor to generate the selection criteria using a machine-learning framework.

19. The non-transitory computer readable storage medium of claim 15, wherein the instructions executable by the processor to to determine the updated priority metric further comprise:
instructions executable by the processor to calculate, using the selected priority models, performance indicator metrics, wherein each of the performance indicator metrics are calculated using a corresponding one of the selected priority models;
instructions executable by the processor to weigh each of the performance indicator metrics with at least one of the weight values included in the selection criteria; and
instructions executable by the processor to generate the updated priority metric based on a weighted combination of the performance indicator metrics and the weights of the selection criteria.

20. The non-transitory computer readable storage medium of claim 15, further comprising:
generate the display interface, the display interface including a list of the component identifiers and priority contribution information, wherein the priority contribution information is prioritized according to prioritization metrics calculated for the component identifiers, wherein the priority contribution information includes performance indicators previously calculated using the production information.
